(19) United States
(12) Patent Application Publication
(10) Pub. No.: US 2015/0248111 A1
(43) Pub. Date: Sep. 3, 2015

(54) SPHERICAL HOLOGRAM GENERATION METHOD AND APPARATUS

(71) Applicant: Electronics and Telecommunications Research Institute, Daejeon (KR)

(72) Inventor: Seung Taik OH, Seoul (KR)

(73) Assignee: Electronics and Telecommunications Research Institute, Daejeon (KR)

(21) Appl. No.: 14/265,048

(22) Filed: Apr. 29, 2014

(30) Foreign Application Priority Data
Feb. 28, 2014 (KR) 10-2014-0024630

(51) Int. Cl. G03H 1/26; G03H 1/08; G03H 1/02

(52) U.S. Cl. CPC G03H 1/268; G03H 1/0248; G03H 1/0891; G03H 2001/269

(57) ABSTRACT

Provided is a spherical hologram generation method and apparatus, the apparatus including a shaper to generate a virtual spherical surface with respect to an object, and dispose a plurality of unit plane holograms on the spherical surface, and a processor to record a light wave related to the object in each of the plurality of unit plane holograms, and restore an omnidirectional stereoscopic image of the object using the recorded light wave.

### CROSS-REFERENCE TO RELATED APPLICATION

This application claims the priority benefit of Korean Patent Application No. 10-2014-0024630, filed on Feb. 28, 2014, in the Korean Intellectual Property Office, the disclosure of which is incorporated herein by reference.

### BACKGROUND

1. Field of the Invention

The present invention relates to a spherical hologram generation method and apparatus for performing an omnidirectional record on a light wave transmitted through an object using a plurality of plane holograms.

2. Description of the Related Art

In general, an existing hologram may be represented by an analog film of a planar shape or a spatial light modulator (SLM). Such a planar hologram may provide only a point of view within a predetermined angle and thus, omnidirectional observation of an object may not be possible. A spherical hologram in which a light wave transmitted through an object is recorded on a spherical surface may need to be used for the omnidirectional observation.

In theory, the spherical hologram may perform the omnidirectional observation on the object despite a difficulty in implementation attributed to a difficulty in fabrication of the SLM or a film of a shape of a spherical surface.

In a view of a computer-generated hologram (CGH), calculation of the spherical hologram may be considered inefficient. In general, the CGH may be acquired through a simulation of light wave diffraction with respect to a virtual three-dimensional model. When a hologram is provided in a planar shape, an efficient calculation may be possible based on a Fourier transform.

Conversely, when the simulation is performed on the light wave diffraction with respect to the virtual three-dimensional model using a hologram provided in a shape of a spherical surface, an efficient calculation may not be possible and a calculation speed may also be slow.

### SUMMARY

An aspect of the present invention provides a spherical hologram generation apparatus for performing an omnidirectional record on a light wave transmitted through an object using a plurality of plane holograms.

Another aspect of the present invention also provides a spherical hologram generation apparatus for performing an omnidirectional record on a light wave transmitted through an object using a plurality of plane holograms, thereby realizing an efficient light wave progress calculation based on a Fourier transform.

According to an aspect of the present invention, there is provided a spherical hologram generation apparatus including a shaper to generate a virtual spherical surface with respect to an object, and dispose a plurality of unit plane holograms on the spherical surface, and a processor to record a light wave related to the object in each of the plurality of unit plane holograms, and restore an omnidirectional stereoscopic image of the object using the recorded light wave.

According to another aspect of the present invention, there is also provided a spherical hologram generation method including generating a virtual spherical surface having an object as a center, setting a plurality of unit plane holograms, disposing the plurality of unit plane holograms on the spherical surface, and acquiring an omnidirectional stereoscopic image of the object using a light wave related to the object recorded in each of the plurality of unit plane holograms.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an example of a configuration of a spherical hologram generation apparatus according to an embodiment of the present invention;

FIG. 2 illustrates an example of a spectrum area corresponding to a unit plane hologram in a spherical hologram generation apparatus according to an embodiment of the present invention;

FIG. 3 illustrates an example of a disposition of a unit plane hologram in a spherical hologram generation apparatus according to an embodiment of the present invention;

FIG. 4 illustrates an example of a spectrum value of a spectrum area corresponding to a unit plane hologram in a spherical hologram generation apparatus according to an embodiment of the present invention;

FIG. 5 illustrates an example of a generation of a spherical hologram in a spherical hologram apparatus according to an embodiment of the present invention; and

FIG. 6 illustrates a spherical hologram generation method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. Hereinafter, a spherical hologram generation apparatus according to an embodiment of the present invention may be based on, for example, a digital holography technology.

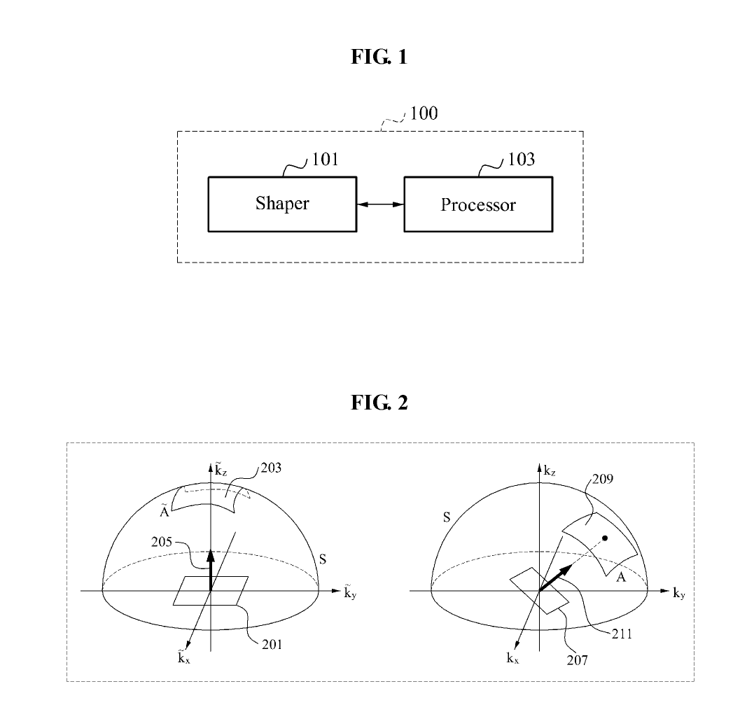

FIG. 1 illustrates an example of a configuration of a spherical hologram generation apparatus 100 according to an embodiment of the present invention. Hereinafter, a spherical hologram may indicate a spherical surface hologram.

Referring to FIG. 1, the spherical hologram generation apparatus 100 may include a shaper 101 and a processor 103.

The shaper 101 may generate a virtual spherical surface with respect to an object. For example, the shaper 101 may generate a trace of a point positioned at a distance set based on a position of the object, to be the spherical surface.

The shaper 101 may dispose a plurality of unit plane holograms on the spherical surface to generate a spherical hologram. For example, the shaper 101 may set the unit plane hologram by determining a size of a pixel and a number of pixels included in a plane hologram.

In a process of disposing the unit plane hologram on the spherical surface, the shaper 101 may dispose each of the plurality of unit plane holograms in a different position to be adjacent to each other, thereby fully covering the spherical surface. As an example, the shaper 101 may match a regular polyhedron, for example, a regular icosahedron to the spherical surface, and correspondingly dispose a center of each of the plurality of unit plane holograms to each vertex of the regular polyhedron.

Also, a view direction of the unit plane hologram may correspond to a vector originating from a center of the spherical surface toward a center of the unit plane hologram.

The processor 103 may record a light wave related to the object in the plurality of unit plane holograms, and restore an omnidirectional stereoscopic image of the object using the recorded light wave. Thus, the process 103 may restore the stereoscopic image of the object using the light wave related to the object recorded in a spherical hologram generated by disposing a plurality of unit plane holograms on a spherical surface.

FIG. 2 illustrates an example of a spectrum area corresponding to a unit plane hologram in a spherical hologram generation apparatus according to an embodiment of the present invention.

Referring to FIG. 2, the spherical hologram generation apparatus may determine a size of a pixel and a number of pixels to set the unit plane hologram. Here, the size of the pixel may be used to determine a maximum value of a spatial frequency, and the maximum value of the spatial frequency may be used to determine an angle of a cone area corresponding to the unit plane hologram and a center of a spherical surface. Also, a spectrum area corresponding to the unit plane hologram may be more densely sampled according to an increase in the number of pixels.

Spectrum areas 203 and 209 corresponding to unit plane holograms 201 and 207 may be positioned on a virtual spherical surface with respect to an angle at which the unit plane holograms 201 and 207 are disposed.

Also, view directions 205 and 211 of the unit plane holograms 201 and 207 may correspond to vectors originating from a center of the spherical surface toward centers of the spectrum areas 203 and 209.

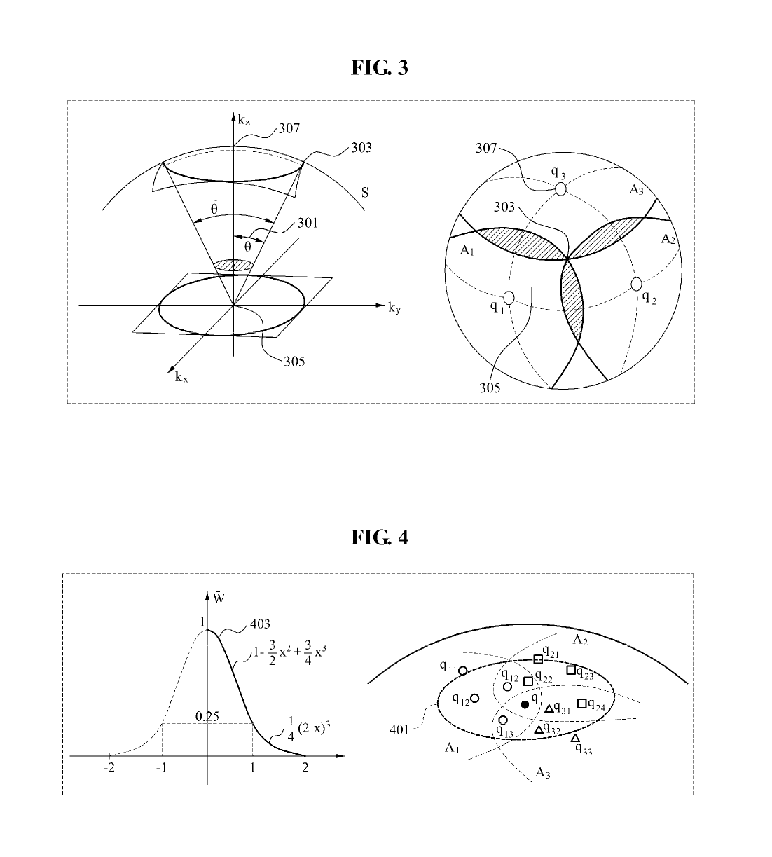

FIG. 3 illustrates an example of a disposition of a unit plane hologram in a spherical hologram generation apparatus according to an embodiment of the present invention.

Referring to FIG. 3, the spherical hologram generation apparatus may set a unit plane hologram by determining a size of a pixel and a number of pixels, and determine a configuration for disposing the unit plane hologram.

The size of the pixel may be used to determine a maximum value of a spatial frequency, and the maximum value of the spatial frequency may be used to determine an angle of a cone area corresponding to the unit plane hologram and a center of a spherical surface. Also, a spectrum area corresponding to the unit plane hologram may be more densely sampled according to an increase in the number of pixels.

An angle 301 of a cone area determined based on a spectrum area corresponding to a unit plane hologram may correspond to an angle formed by a center 303 of a triangle configuring a regular icosahedron matched to the spherical surface, a center 305 of the spherical surface, and a vertex 307 of the triangle. An entire spectrum area including all spectrum areas corresponding to the plurality of unit plane holograms may fully cover the spherical surface.

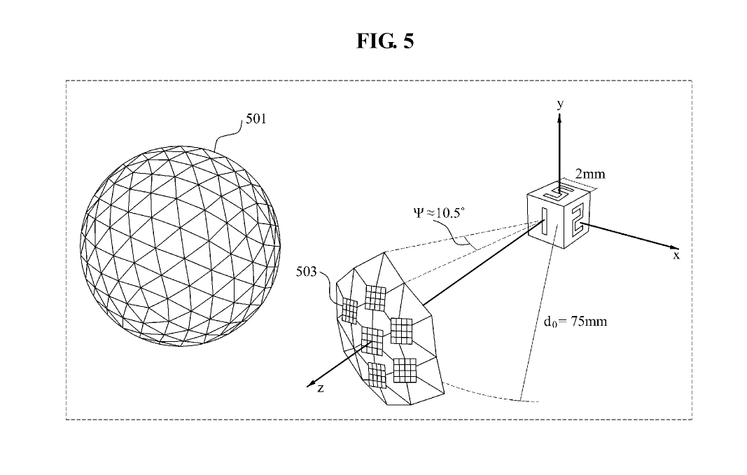

FIG. 4 illustrates an example of a spectrum value of a spectrum area 401 corresponding to a unit plane hologram in a spherical hologram generation apparatus according to an embodiment of the present invention.

Referring to FIG. 4, the spherical hologram generation apparatus may indicate the spectrum value of the spectrum area 401 corresponding to the unit plane hologram of FIG. 3 to be a weighted sum including an end point of a vector included on a corresponding spherical surface. In this instance, the spherical hologram generation apparatus may calculate a weight using a smoothing kernel 403, thereby improving a numerical calculation efficiency.

FIG. 5 illustrates an example of a generation of a spherical hologram in a spherical hologram apparatus according to an embodiment of the present invention.

Referring to FIG. 5, the spherical hologram generation apparatus may place, for example, a 2 millimeter (mm) die at a center of a sphere having a 75 mm radius, and record a light wave in a plurality of unit plane holograms disposed on a spherical surface. For example, the spherical hologram generation apparatus may match a regular icosahedral mesh structure 501 having 362 vertices to the spherical surface and dispose each of a plurality of unit plane holograms 503 to each vertex, thereby generating a spherical hologram. In this instance, the spherical hologram generation apparatus may adjacently dispose each of the plurality of unit plane holograms to a difference position to fully cover the spherical surface.

Here, a number of pixels included in the unit plane hologram may be 5424*5424, a size of a pixel may be 2.93776×10⁻⁶ (m) and, when a wavelength of a single color light wave is 6.33×10⁻⁷, a spectrum area may be approximately 12.3695 degrees (°).

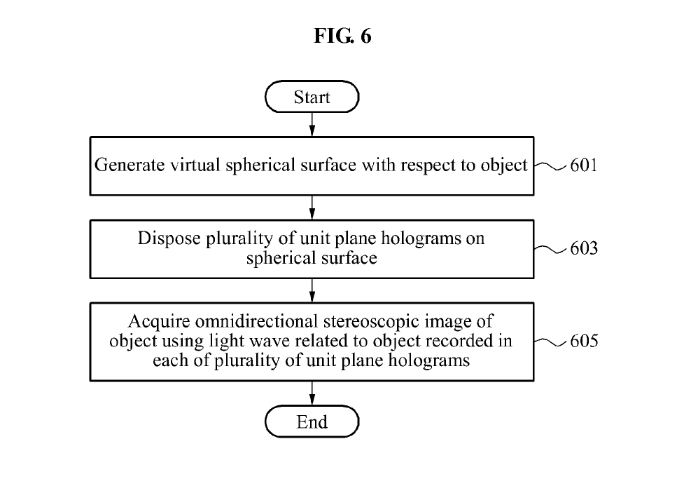

FIG. 6 illustrates a spherical hologram generation method according to an embodiment of the present invention.

Referring to FIG. 6, in operation 601, a spherical hologram generation apparatus may generate a virtual spherical surface with respect to an object. The spherical hologram generation apparatus may generate a trace of a point positioned at a distance set based on a position of the object to be the spherical surface.

In operation 603, the spherical hologram generation apparatus may dispose a plurality of unit plane holograms on the spherical surface.

The spherical hologram generation apparatus may set a unit plane hologram by determining a size of a pixel and a number of pixels included in a plane hologram.

The spherical hologram generation apparatus may dispose each of the plurality of unit plane holograms to a different position to fully cover the spherical surface. As an example, the spherical hologram generation apparatus may match a regular polyhedron, for example, a regular icosahedron to the spherical surface, and correspondingly dispose a center of each of the plurality of unit plane holograms to each vertex of the regular polyhedron.

Also, a view direction of the unit plane hologram may correspond to a vector originating from a center of the spherical surface toward a center of the unit plane hologram.

In operation 605, the spherical hologram generation apparatus may acquire an omnidirectional stereoscopic image of the object using a light wave related to the object recorded in each of the plurality of unit plane holograms.

According to an aspect of the present invention, it is possible to provide a spherical hologram generation apparatus for performing an omnidirectional record on a light wave transmitted through an object using a plurality of plane holograms.

According to another aspect of the present invention, it is possible to provide a spherical hologram generation apparatus for performing an omnidirectional record on a light wave transmitted through an object using a plurality of plane holograms, thereby realizing an efficient light wave progress calculation based on a Fourier transform.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents. Thus, other implementations, alternative embodiments and equivalents to the claimed subject matter are construed as being within the appended claims.

What is claimed is:

1. A spherical hologram generation apparatus comprising:
a shaper to generate a virtual spherical surface with respect to an object, and dispose a plurality of unit plane holograms on the spherical surface; and
a processor to record a light wave related to the object in each of the plurality of unit plane holograms, and restore an omnidirectional stereoscopic image of the object using the recorded light wave.

2. The apparatus of claim 1, wherein the shaper sets the unit plane hologram by determining a size of a pixel and a number of pixels comprised in a plane hologram.

3. The apparatus of claim 1, wherein the shaper disposes each of the plurality of unit plane holograms to a different position to fully cover the spherical surface.

4. The apparatus of claim 1, wherein the shaper matches a regular polyhedron to the spherical surface, and correspondingly disposes a center of each of the plurality of unit plane holograms to each vertex of the regular polyhedron.

5. The apparatus of claim 1, wherein a view direction of the unit plane hologram corresponds to a vector originating from a center of the spherical surface toward a center of the unit plane hologram.

6. The apparatus of claim 1, wherein the shaper generates, to be the spherical surface, a trace of a point positioned at a distance set based on a position of the object.

7. A spherical hologram generation apparatus comprising:
a shaper to set a plurality of unit plane holograms, dispose the plurality of unit plane holograms on a virtual spherical surface having an object as a center, and generate a spherical hologram; and
a processor to restore a stereoscopic image of the object using a light wave related to the object recorded in the spherical hologram.

8. The apparatus of claim 7, wherein the shaper disposes each of the plurality of unit plane holograms to a different position to fully cover the spherical surface.

9. The apparatus of claim 7, wherein the shaper matches a regular polyhedron to the spherical surface, and correspondingly disposes a center of each of the plurality of unit plane holograms, to each vertex of the regular polyhedron.

10. A spherical hologram generation method comprising:
generating a virtual spherical surface having an object as a center;
setting a plurality of unit plane holograms;
disposing the plurality of unit plane holograms on the spherical surface; and
acquiring an omnidirectional stereoscopic image of the object using a light wave related to the object recorded in each of the plurality of unit plane holograms.

11. The method of claim 10, wherein the setting comprises setting the unit plane holograms by determining a size of a pixel and a number of pixels included in a plane hologram.

12. The method of claim 10, wherein the disposing comprises disposing each of the plurality of unit plane holograms to a different position to fully cover the spherical surface.

13. The method of claim 10, wherein the disposing comprises matching a regular polyhedron to the spherical surface and correspondingly disposing a center of each of the plurality of unit plane holograms to each vertex of the regular polyhedron.

14. The method of claim 10, wherein a view direction of the unit plane hologram corresponds to a vector originating from a center of the spherical surface toward a center of the unit plane hologram.

15. The method of claim 10, wherein the generating comprises generating, to be the spherical surface, a trace of a point positioned at a distance set based on a position of the object.
